(19) United States
(12) Patent Application Publication
(10) Pub. No.: US 2014/0223320 A1
(43) Pub. Date: Aug. 7, 2014

(54) INFORMATION PROCESSING SYSTEM, INFORMATION PROCESSING DEVICE, AND METHOD

(71) Applicants: Kazunori SUGIMURA, Kanagawa (JP); Kohta NAGAI, Kanagawa (JP); Ryo TAKEMOTO, Kanagawa (JP); Minami OGAWA, Tokyo (JP)

(72) Inventors: Kazunori SUGIMURA, Kanagawa (JP); Kohta NAGAI, Kanagawa (JP); Ryo TAKEMOTO, Kanagawa (JP); Minami OGAWA, Tokyo (JP)

(73) Assignee: RICOH COMPANY, LTD., Tokyo (JP)

(21) Appl. No.: 14/165,770

(22) Filed: Jan. 28, 2014

(30) Foreign Application Priority Data
Feb. 6, 2013 (JP) 2013-021268
Jan. 17, 2014 (JP) 2014-007160

(51) Int. Cl. H04L 29/08; G06F 3/0484

(52) U.S. Cl. CPC H04L 67/36; G06F 3/0484
USPC 715/740

(57) ABSTRACT

An information processing system includes one or more information processing devices, and includes a display control unit configured to provide, to an external device, a screen of one or more basic processes relevant to a portal service; a common function providing unit configured to provide, to the display control unit, one or more common functions used by the one or more basic processes; and a base function providing unit configured to provide a base function to the common function providing unit.

### BACKGROUND OF THE INVENTION

1. Field of the Invention

The present invention relates to an information processing system, an information processing device, and a method.

2. Description of the Related Art

In recent years, new service providing formats have been increasing, by which the user can use only necessary functions at necessary times. For example, there are service providing formats such as SaaS (Software as a Service), which is a new software using format by which the user can freely select only the functions that he desires to use and use the selected services, and cloud computing, by which computing resources on the Internet are combined and application services with enhanced added-value are provided to end users.

There is conventionally known a user interactive service cooperation system, in which the user sequentially calls web service providing servers via a web portal server, and service cooperation is implemented while user interactions are performed between the user terminal and the web service providing server according to need (see, for example, Patent Document 1).

Patent Document 1: Japanese Laid-Open Patent Publication No. 2012-79210

In the conventional user interactive service cooperation system, the web portal server receives a call for a web service providing server from the user, and implements service cooperation of web services provided by the web service providing server. However, it has not been easy to develop a web portal server for implementing service cooperation by a wide variety of web services.

This is a common problem among a web portal server, and also various information processing devices for providing portal services.

### SUMMARY OF THE INVENTION

The present invention provides an information processing system, an information processing device, and a method, in which one or more of the above-described disadvantages are eliminated.

According to an aspect of the present invention, there is provided an information processing system including one or more information processing devices, the information processing system including a display control unit configured to provide, to an external device, a screen of one or more basic processes relevant to a portal service; a common function providing unit configured to provide, to the display control unit, one or more common functions used by the one or more basic processes; and a base function providing unit configured to provide a base function to the common function providing unit.

According to an aspect of the present invention, there is provided an information processing device including a display control unit configured to provide, to an external device, a screen of one or more basic processes relevant to a portal service; a common function providing unit configured to provide, to the display control unit, one or more common functions used by the one or more basic processes; and a base function providing unit configured to provide a base function to the common function providing unit.

According to an aspect of the present invention, there is provided a method performed by an information processing system including one or more information processing devices, the method including providing, by a display control unit, to an external device, a screen of one or more basic processes relevant to a portal service; providing, by a common function providing unit, to the display control unit, one or more common functions used by the one or more basic processes; and providing, by a base function providing unit, a base function to the common function providing unit.

### BRIEF DESCRIPTION OF THE DRAWINGS

Other objects, features and advantages of the present invention will become more apparent from the following detailed description when read in conjunction with the accompanying drawings, in which:

FIG. 1 is a configuration diagram of an example of an information processing system according to a first embodiment;

FIG. 2 is a configuration diagram of another example of the service providing system;

FIG. 3 is a hardware configuration diagram of an example of a computer system;

FIG. 4 is a process block diagram of an example of a service providing system according to the first embodiment;

FIG. 5 is a configuration diagram of an example of organization information;

FIG. 6 is a configuration diagram of an example of user information;

FIG. 7 is a configuration diagram of an example of license information;

FIG. 8 is a configuration diagram of an example of device information;

FIG. 9 is a configuration diagram of an example of authority information;

FIG. 10 is a process block diagram of another example of the service providing system according to the first embodiment;

FIG. 11 is a configuration diagram of an example of a portal service application;

FIG. 12 is a sequence diagram expressing an example of processing procedures for displaying a user management screen;

FIG. 13 is an image diagram of an example of a user management screen;

FIG. 14 is an image diagram of an example of a service management screen;

FIG. 15 is a sequence diagram expressing an example of processing procedures for displaying a user management screen when an error occurs;

FIG. 16 is a sequence diagram expressing an example of processing procedures for displaying an application launcher screen;

FIG. 17 is an image diagram of an example of an application launcher screen;

FIG. 18 is an image diagram of another example of an application launcher screen;

FIG. 19 is an explanatory diagram expressing processing procedures performed by a scan service application for acquiring setting information from a base service;

FIG. 20 is an explanatory diagram expressing processing procedures performed by a print service application for registering jobs in a base service; and

FIG. 21 is a configuration diagram of an example of an application using the common client unit.

### DETAILED DESCRIPTION OF THE PREFERRED EMBODIMENTS

A description is given, with reference to the accompanying drawings, of embodiments of the present invention.

### First Embodiment

### System Configuration

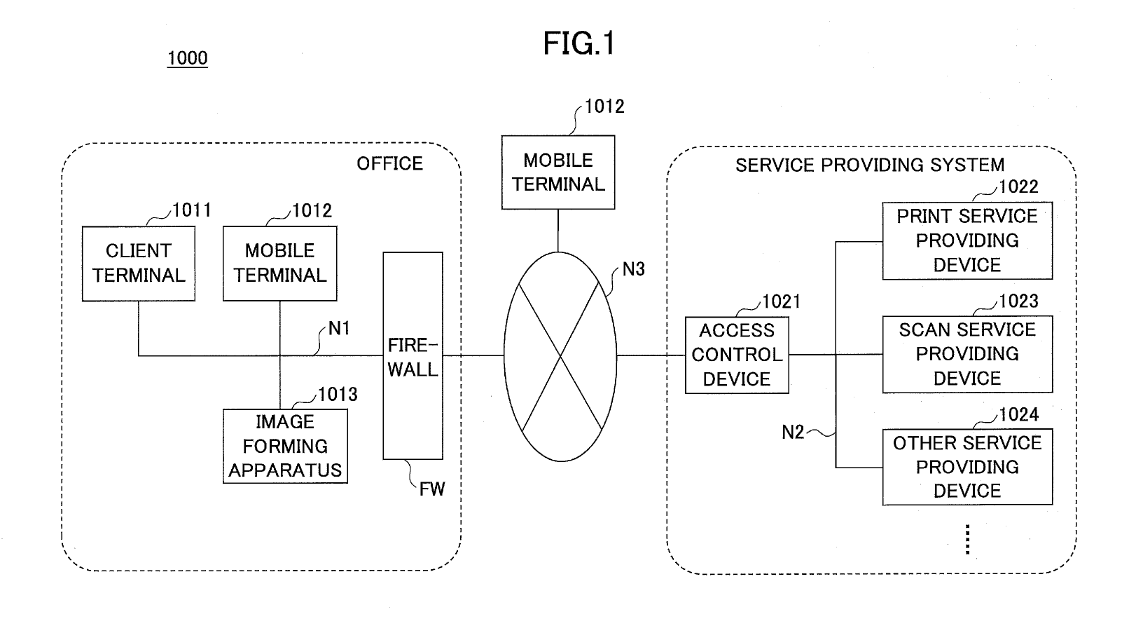

FIG. 1 is a configuration diagram of an example of an information processing system according to a first embodiment. An information processing system 1000 illustrated in FIG. 1 includes, for example, a network N1 such as a network in an office, a network N2 of a service providing system represented by a cloud service, and a network N3 such as the Internet.

The network N1 is a private network behind a firewall FW. The firewall FW is installed at the contact point between the network N1 and the network N3, and detects and blocks unauthorized accesses. To the network N1, a client terminal 1011, a mobile terminal 1012, and an image forming apparatus 1013 such as a multifunction peripheral, are connected.

The client terminal 1011 is an example of a terminal device. The client terminal 1011 is realized by an information processing device in which a typical OS is installed. The client terminal 1011 includes a unit for performing radio communication or a unit for performing cable communication. The client terminal 1011 is a terminal that can be operated by a user, such as a tablet PC and a notebook PC.

The mobile terminal 1012 is an example of a terminal device. The mobile terminal 1012 includes a unit for performing radio communication or a unit for performing cable communication. The mobile terminal 1012 is a terminal that is portable for a user, such as a smartphone, a mobile phone, a tablet PC, and a notebook PC.

The image forming apparatus 1013 is a device having an image forming function, such as a multifunction peripheral. The image forming apparatus 1013 includes a unit for performing radio communication or a unit for performing cable communication. The image forming apparatus 1013 is a device for performing processes relevant to image formation, such as a multifunction peripheral, a copier, a scanner, a printer, a laser printer, a projector, and an electronic blackboard. FIG. 1 illustrates an example including one of each of the client terminal 1011, the mobile terminal 1012, and the image forming apparatus 1013; however, there may be a plurality of each of these devices.

The network N2 is connected to the network N3 by an access control device 1021. The security of the network N2 is protected by the access control device 1021. To the network N2, a print service providing device 1022, a scan service providing device 1023, and another service providing device 1024 are connected.

In the information processing system 1000 of FIG. 1, the access control device 1021, the print service providing device 1022, the scan service providing device 1023, and the other service providing device 1024 realize the service providing system. The print service providing device 1022, the scan service providing device 1023, and the other service providing device 1024 provide a print service, a scan service, and other services.

The access control device 1021 controls the operation of logging into a print service provided by the print service providing device 1022 and a scan service provided by the scan service providing device 1023.

The access control device 1021, the print service providing device 1022, the scan service providing device 1023, and the other service providing device 1024 are realized by one or more information processing devices.

The access control device 1021, the print service providing device 1022, the scan service providing device 1023, and the other service providing device 1024 may be realized by being integrated in a single information processing device, or may be realized by being distributed across a plurality of information processing devices.

Part of the services on the network N2 side may be outside the network N2. The mobile terminal 1012 may be outside the network N1 that is a network inside the office. In the example of the information processing system 1000 of FIG. 1, the mobile terminal 1012 is in the network N1 and in the network N3.

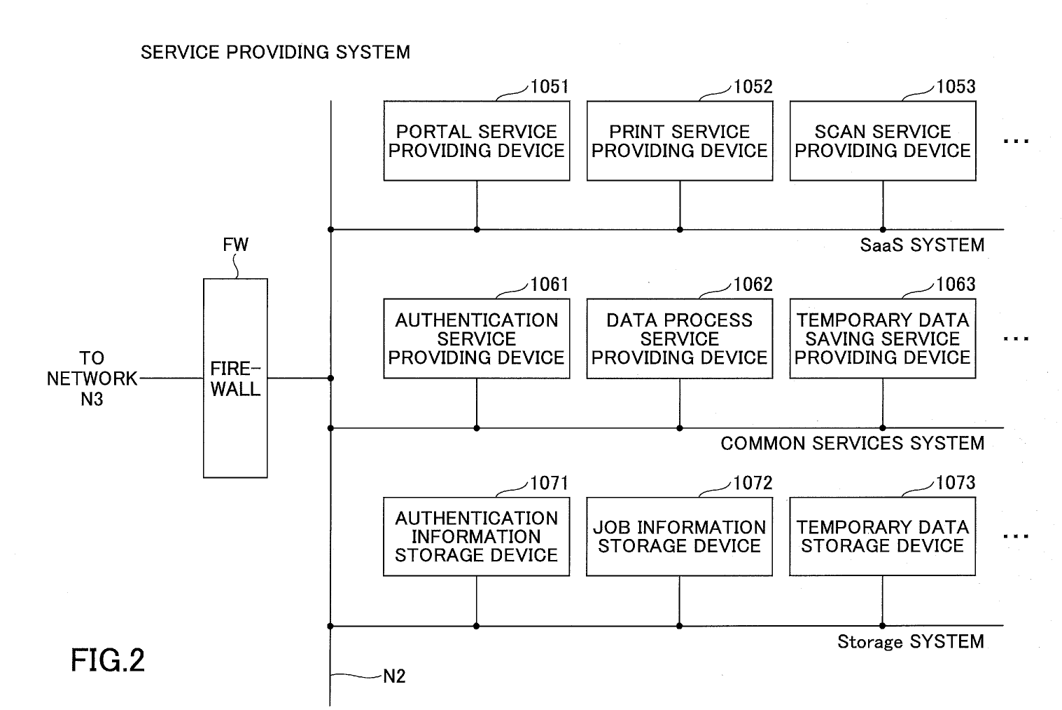

The configuration of the service providing system of FIG. 1 is one example; the service providing system may be realized by the configuration illustrated in FIG. 2. FIG. 2 is a configuration diagram of another example of the service providing system. In the service providing system of FIG. 2, the network N2 is connected to the network N3 by a firewall FW.

In the network N2, service providing devices of a SaaS (Software as a Service) system, service providing devices of a common service (Network Service Platform) system, and storage devices of the storage system are connected. The service providing device of a common service system provides a service that can be commonly used by the service providing devices of the SaaS system.

The service providing devices of the SaaS system include service providing devices according to the service to be provided, such as a portal service providing device 1051, a print service providing device 1052, and a scan service providing device 1053. Furthermore, the service providing devices of the common service system include service providing devices according to a common service to be provided, such as an authentication service providing device 1061, a data process service providing device 1062, and a temporary data saving service providing device 1063. The storage devices of the storage system include storage devices according to the information (data) to be stored, such as an authentication information storage device 1071, a job information storage device 1072, and a temporary data storage device 1073.

In the service providing system of FIG. 2, security is protected by authentication services provided by, for example, the firewall FW and the authentication service providing device 1061. Note that the configuration of the service providing system of FIG. 2 is also one example, and the service providing system may have other configurations.

Hardware Configuration

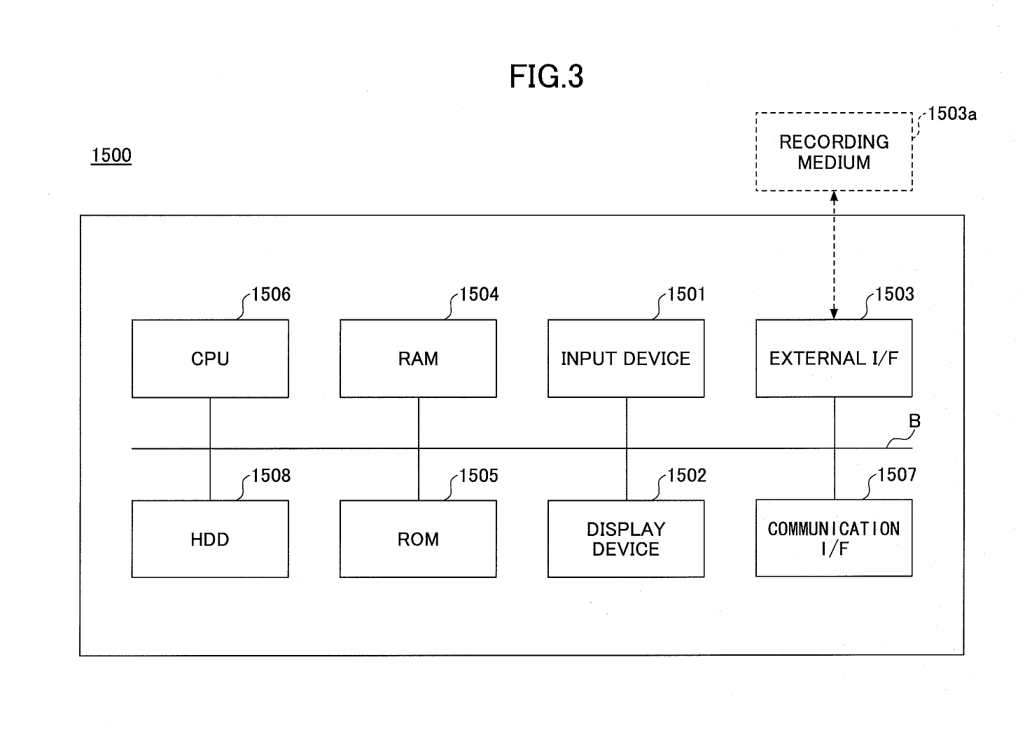

The client terminal 1011, the mobile terminal 1012, the access control device 1021, the print service providing device 1022, the scan service providing device 1023, and the other service providing device 1024 are realized by, for example, a computer system having a hardware configuration as illustrated in FIG. 3.

The service providing devices of the SaaS system, the service providing devices of the common service system, and the storage devices of the storage system illustrated in FIG. 2 may also be realized by, for example, a computer system having a hardware configuration as illustrated in FIG. 3.

FIG. 3 is a hardware configuration diagram of an example of a computer system. A computer system 1500 illustrated in FIG. 3 includes an input device 1501, a display device 1502, an external I/F 1503, a RAM (Random Access Memory) 1504, a ROM (Read-Only Memory) 1505, a CPU (Central Processing Unit) 1506, a communication I/F 1507, and a HDD (Hard Disk Drive) 1508, which are interconnected by a bus B.

The input device 1501 includes a keyboard, a mouse, and a touch panel, which are used by the user for inputting operation signals. The display device 1502 includes a display, etc., and displays processing results obtained by the computer system 1500.

The communication I/F 1507 is an interface for connecting the computer system 1500 to the networks N1 through N3. Accordingly, the computer system 1500 can perform data communication via the communication I/F 1507.

The HDD 1508 is a nonvolatile storage device storing programs and data. Examples of the stored programs and data are an OS (Operating System) which is the basic software for controlling the entire computer system 1500, and application software for providing various functions in the OS.

The HDD 1508 manages the stored programs and data by a predetermined file system and/or a DB (database). The external I/F 1503 is an interface between the computer system 1500 and an external device. An example of the external device is a recording medium 1503a. Accordingly, the computer system 1500 can read data from and/or write data in the recording medium 1503a via the external I/F 1503. Examples of the recording medium 1503a are a flexible disk, a CD (Compact Disk), a DVD (Digital Versatile Disk), an SD memory card, and a USB memory (Universal Serial Bus memory).

The ROM 1505 is a nonvolatile semiconductor memory (storage device) that can hold programs and data even after the power is turned off. The ROM 1505 stores programs and data such as BIOS (Basic Input/Output System) that is executed when the computer system 1500 is activated, OS settings, and network settings. The RAM 1504 is a volatile semiconductor memory (storage device) for temporarily storing programs and data

The CPU 1506 is a processor for loading the programs and data from storage devices such as the ROM 1505 and the HDD 1508 into the RAM 1504, and executing processes, control the entire computer system 1500 and realize functions.

The client terminal 1011, the mobile terminal 1012, the access control device 1021, the print service providing device 1022, the scan service providing device 1023, and the other service providing device 1024 can realize various processes as described below, by the hardware configuration of the computer system 1500. Furthermore, the service providing device of the SaaS system, the service providing device of the common service system, and the storage device of the storage system can also can realize various processes as described below, by the hardware configuration of the computer system 1500. Note that descriptions of hardware configurations of the image forming apparatus 1013 and the firewall FW illustrated in FIG. 1 are omitted.

Software Configuration

Service Providing System

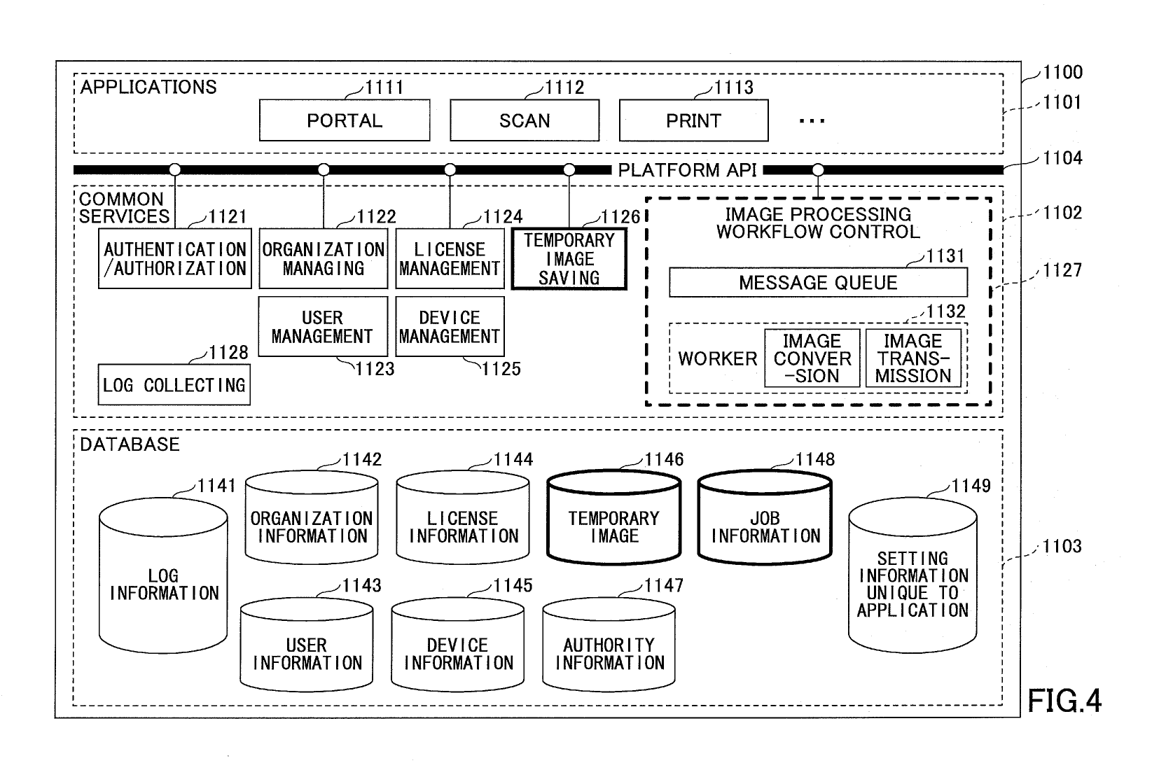

The service providing system according to the first embodiment is realized by, for example, process blocks as illustrated in FIG. 4. FIG. 4 is a process block diagram of an example of a service providing system according to the first embodiment.

A service providing system 1100 realizes applications 1101, common services 1102, a database (DB) 1103, and a platform API (Application Programming Interface) 1104, by executing programs.

The applications 1101 include, for example, a portal service application 1111, a scan service application 1112, and a print service application 1113.

The portal service application 1111 is an application for providing a portal service. A portal service provides a service acting as an entrance for using the service providing system 1100. The scan service application 1112 is an application for providing a scan service. The print service application 1113 is an application for providing a print application. The applications 1101 may include other service applications.

The platform API 1104 is an interface for using the common services 1102 by the applications 1101, by the portal service application 1111, the scan service application 1112, and the print service application 1113. The platform API 1104 is an interface that is defined in advance, which is provided for the common services 1102 to receive requests from the applications 1101. The platform API 1104 is constituted by, for example, functions and classes.

The platform API 1104 is realized by, for example, a Web API that can be used via the network, when the service providing system 1100 is constituted by a plurality of information processing devices.

The common services 1102 include an authentication/authorization unit 1121, an organization managing unit 1122, a user management unit 1123, a license management unit 1124, a device management unit 1125, a temporary image saving unit 1126, an image processing workflow control unit 1127, and a log collecting unit 1128.

Furthermore, the image processing workflow control unit 1127 includes a message queue 1131, and at least one worker 1132. The worker 1132 realizes functions such as image conversion and image transmission.

The authentication/authorization unit 1121 executes authentication/authorization based on a log in request from office devices such as the client terminal 1011 and the image forming apparatus 1013. The office device is a collective term of the client terminal 1011, the mobile terminal 1012, and the image forming apparatus 1013.

The authentication/authorization unit 1121 authenticates/authorizes a user by accessing, for example, a user information storage unit 1143, a license information storage unit 1144, and an authority information storage unit 1147, described below. Furthermore, the authentication/authorization unit 1121 authenticates, for example, the image forming apparatus 1013 by accessing, for example, the organization information storage unit 1142, the license information storage unit 1144, and the device information storage unit 1145, described below.

The organization managing unit 1122 manages organization information stored in an organization information storage unit 1142 described below. The user management unit 1123 manages user information stored in the user information storage unit 1143 described below. Furthermore, the user management unit 1123 manages authority information stored in the authority information storage unit 1147 described below.

The license management unit 1124 manages license information stored in the license information storage unit 1144 described below. The device management unit 1125 manages device information stored in a device information storage unit 1145 described below. The temporary image saving unit 1126 saves temporary images in a temporary image storage unit 1146 described below, and acquires temporary images from the temporary image storage unit 1146.

The image processing workflow control unit 1127 controls a workflow relevant to image processing, based on a request from the applications 1101. The message queue 1131 includes a queue corresponding to the type of process. The image processing workflow control unit 1127 submits the message of the request relevant to the process (job), in the queue corresponding to the type of the job.

The worker 1132 monitors the corresponding queue. When a message is submitted in the queue, the worker 1132 performs a process such as image conversion and image transmission according to the type of the corresponding job. Note that the submitted message may be subjectively read (pulled) by the worker 1132, or may be provided (pushed) from the queue to the worker 1132.

The database 1103 includes a log information storage unit 1141, an organization information storage unit 1142, a user information storage unit 1143, a license information storage unit 1144, a device information storage unit 1145, a temporary image storage unit 1146, an authority information storage unit 1147, a job information storage unit 1148, and a setting information storage unit 1149 unique to an application.

The log information storage unit 1141 stores log information. The organization information storage unit 1142 stores organization information described below. The user information storage unit 1143 stores user information described below. The license information storage unit 1144 stores license information described below. The device information storage unit 1145 stores device information described below.

The temporary image storage unit 1146 stores a temporary image. A temporary image is, for example, a file or data of a scan image to be processed by the worker 1132. The authority information storage unit 1147 stores authority information described below. The job information storage unit 1148 stores information (job information) of a request relevant to a process (job). The setting information storage unit 1149 unique to an application stores setting information unique to the application 1101.

The service providing system 1100 functions as an integrated base for providing a common service such as a workflow relevant to authentication/authorization and image processing, and a group of services providing application services by using the function of the integrated base, such as a scan service, a print service, and a portal service.

The integrated base is constituted by, for example, the common services 1102, the database 1103, and the platform API 1104. The group of services is constituted by, for example, the applications 1101.

The service providing system 1100 illustrated in FIG. 4 can easily develop the applications 1101 using the platform API 1104, according to the configuration in which the group of services and the integrated base are separated.

Note that the classification form of the process blocks of the service providing system 1100 illustrated in FIG. 4 is one example; it is not essential that the applications 1101, the common services 1102, and the database 1103 are classified into a hierarchy as illustrated in FIG. 4. As long as the process of the service providing system 1100 according to the first embodiment can be performed, the hierarchical relationship illustrated in FIG. 4 is not limited to a particular relationship.

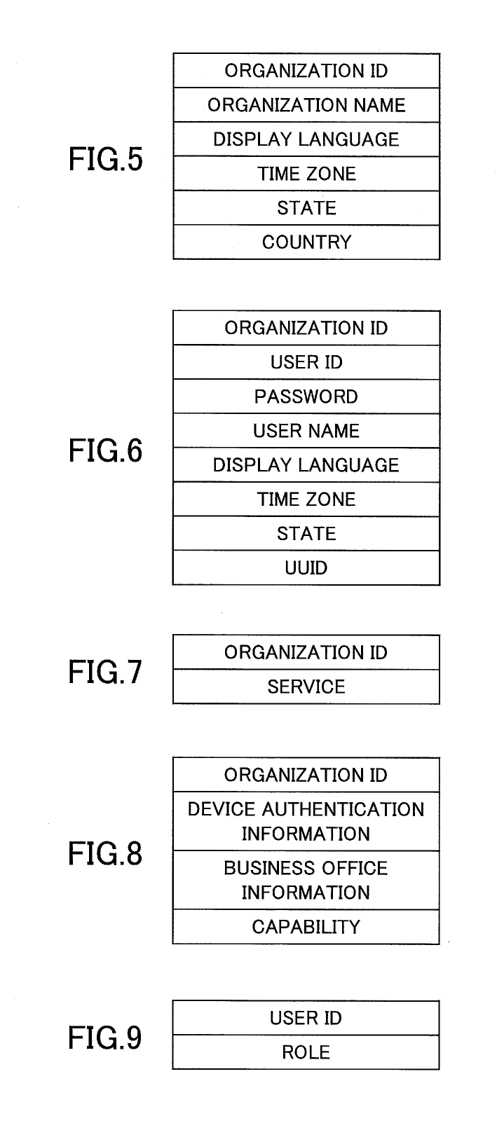

FIG. 5 is a configuration diagram of an example of organization information. The organization information illustrated in FIG. 5 includes, as data items, an organization ID, an organization name, a display language, the time zone, a state, and a country. The organization ID is information for identifying a group such as a company and a department. The organization ID is not limited to the word “organization”; for example, the information may be for identifying a contract. Note that the organization ID is unique.

The organization name expresses the name of a group such as a company and a department. The display language expresses the language used for expressing the name of a group such as a company and a department. The time zone expresses the standard time used by a group such as a company and a department. A state expresses the state of a group such as a company and a department. A country expresses a name of a country to which a group such as a company and a department belongs.

FIG. 6 is a configuration diagram of an example of user information. The user information illustrated in FIG. 6 includes, as data items, an organization ID, a user ID, a password, a user name, a display language, a time zone, and a state.

The user ID and the password are information for identifying a user (user identification information). The user ID may be a user name. Furthermore, a password is not essential. Note that the user ID and password managed by the same organization ID are unique, but may be overlapping with another user ID and password if the organization ID is different.

Furthermore, as the user ID, information for identifying an electronic medium (for example, an IC card) held by the user may be used. As the electronic medium held by the user, an IC card, a mobile phone, a tablet terminal, and an electronic book terminal may be used. As the information for identifying an electronic medium, a card ID, a serial ID, a telephone number of a mobile phone, and profile information of a terminal may be used. The information for identifying an electronic medium may be used in combination.

The user name expresses the name of the user. The display language expresses the language used for displaying the user name. The time zone is the standard time used by the user. The state expresses the state of the user. The country expresses the name of the country to which the user belongs.

FIG. 7 is a configuration diagram of an example of license information. The license information illustrated in FIG. 7 includes, as data items, an organization ID and a service. The service is information for identifying a service (service identification information). The license information expresses at least one service which can be used by an organization identified by the organization ID. The license information is created in a case where, for example, there are one or more licenses for valid services belonging to an organization.

FIG. 8 is a configuration diagram of an example of device information. The device information illustrated in FIG. 8 includes, as data items, an organization ID, device authentication information, business office information, and capability. The device authentication information is information used for device authentication, which is performed for determining whether an office device fulfills a particular condition. The device authentication information may be an ID indicating that a particular application is installed in the office device, or a device number indicating a particular office device. The business office information expresses, for example, the business office at which the office device is installed. The capability expresses, for example, the capability of the office device.

FIG. 9 is a configuration diagram of an example of authority information. The authority information illustrated in FIG. 9 includes, as data items, a user ID and a role. The role expresses the role of the user. As the role of the user, for example, an administrator and a general user are included.

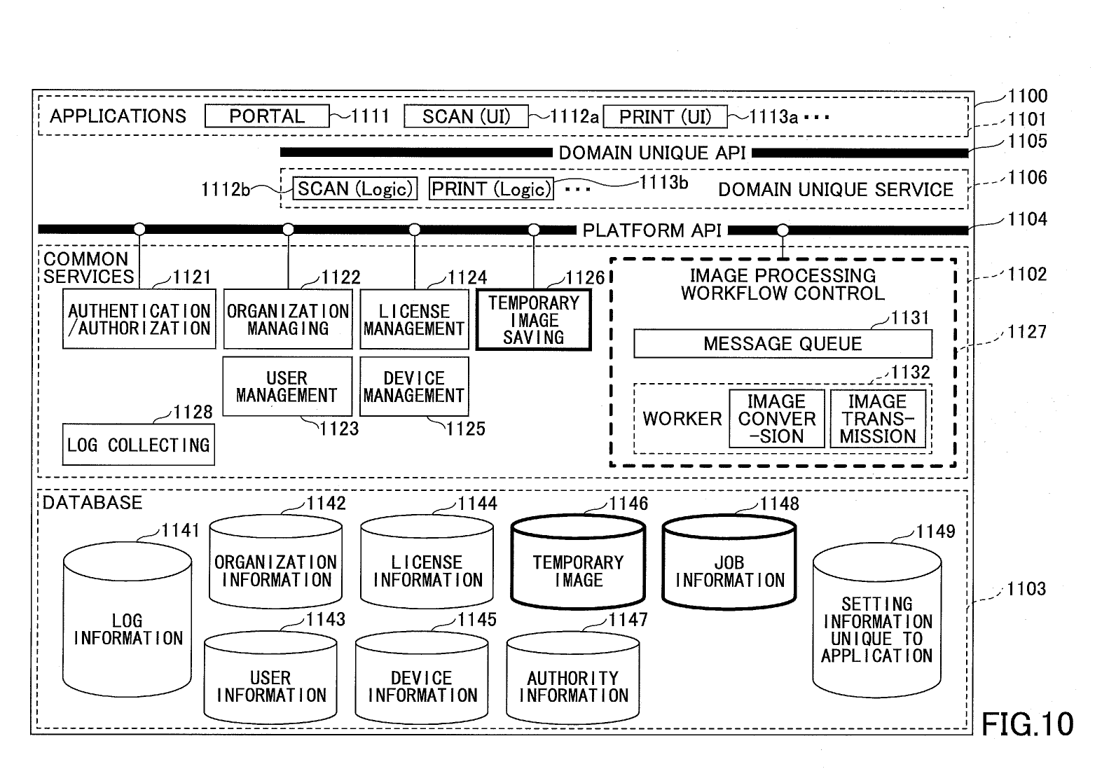

Note that the process blocks of the service providing system 1100 illustrated in FIG. 4 may be, for example, process blocks as illustrated in FIG. 10. FIG. 10 is a process block diagram of another example of the service providing system according to the first embodiment. Note that the service providing system 1100 illustrated in FIG. 10 is the same as the service providing system 1100 illustrated in FIG. 4 except for some elements, and therefore descriptions of the same elements are omitted.

The service providing system 1100 illustrated in FIG. 10 realizes a domain unique API 1105 and a domain unique service 1106, in addition to the applications 1101, the common services 1102, the database (DB) 1103, and the platform API (Application Programming Interface) 1104, by executing programs.

The service providing system 1100 illustrated in FIG. 10 is different from the service providing system 1100 illustrated in FIG. 4, in terms of the applications 1101, the domain unique API 1105, and the domain unique service 1106. The applications 1101 illustrated in FIG. 10 include, for example, the portal service application 1111, a UI unit of a scan service application 1112a, and a UI unit of a print service application 1113a. Furthermore, the domain unique services 1106 include, for example, a logic unit of a scan application 1112b and a logic unit of a print service application 1113b.

The logic unit of a scan application 1112b and the logic unit of a print service application 1113b, which are logics unique to the domain, receive accesses from clients other than the web browser of the mobile terminal 1012 and the image forming apparatus 1013. In clients other than the web browser, UI units such as the UI unit of a scan service application 1112a are disposed on the client side, and therefore the server side only needs to provide the domain unique API 1105.

As described above, in the service providing system 1100 illustrated in FIG. 10, the UI units such as the UI unit of a scan service application 1112a receive accesses from the web browser. Furthermore, the logic units such as the logic unit of a scan application 1112b receive accesses from clients other than the web browser. Because the frequency of accesses from the web browser is different from the frequency of accesses from clients other than the web browser, the scan service application 1112a and the scan application 1112b are provided as separate servers, so as to efficiently perform the scaling out accompanying an increase in the frequency. Furthermore, in the service providing system 1100 illustrated in FIG. 10, multiple applications can be constructed by using domain unique APIs in combination.

### Portal Service Application 1111

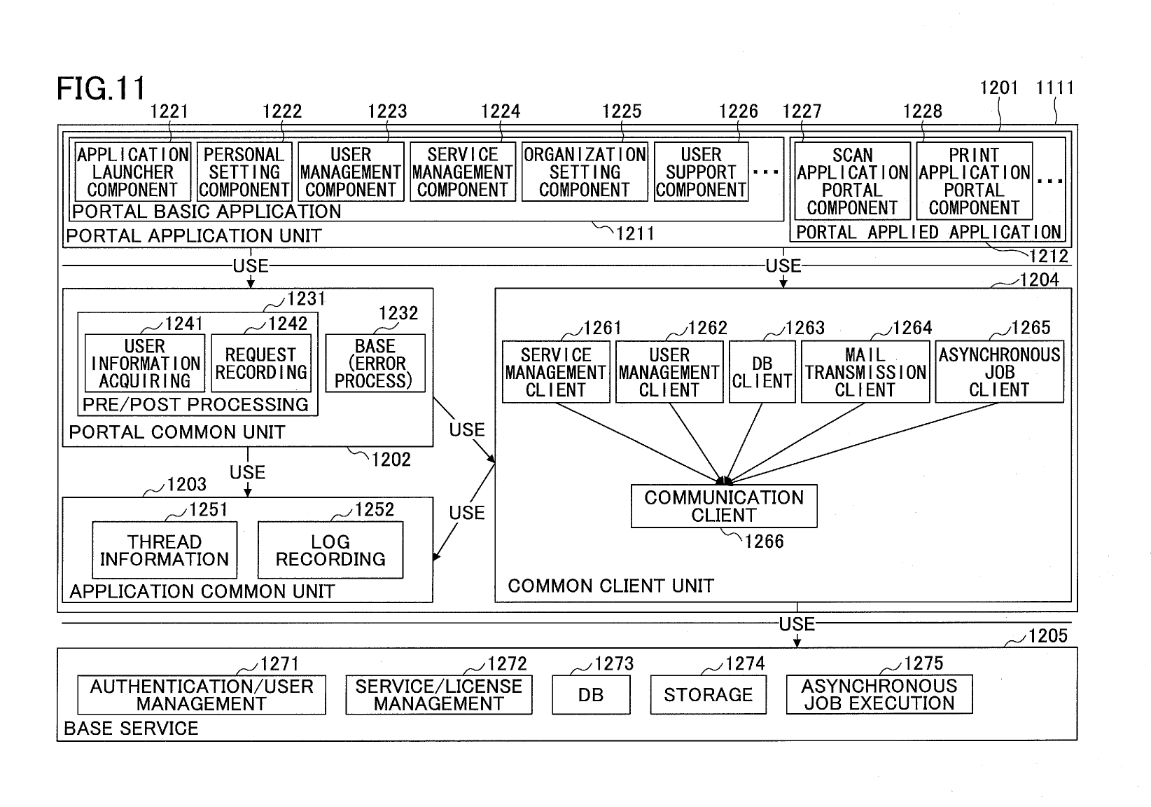

FIG. 11 is a configuration diagram of an example of the portal service application 1111. The portal service application 1111 includes a portal application unit 1201, a portal common unit 1202, an application common unit 1203, and a common client unit 1204.

The portal application unit 1201 includes components 1211 of portal basic applications and components 1212 of portal applied applications.

In FIG. 11, as examples of the components 1211 of portal basic applications, an application launcher component 1221, a personal setting component 1222, a user management component 1223, a service management component 1224, an organization setting component 1225, and a user support component 1226 are illustrated. Furthermore, as examples of the components 1212 of portal applied applications, a scan application portal component 1227, and a print application portal component 1228 are illustrated.

The components 1211 of portal basic applications and the components 1212 of portal applied applications of FIG. 11 are realized by, for example, portlets. A portlet is an attachable/removable UI component that is managed/displayed by a portal.

The portal application unit 1201 uses functions provided by the portal common unit 1202, the application common unit 1203, and the common client unit 1204, and performs processes relevant to the portal. The components 1211 of portal basic applications and the components 1212 of portal applied applications share the functions provided by the portal common unit 1202, the application common unit 1203, and the common client unit 1204.

Note that the components 1211 of portal basic applications and the components 1212 of portal applied applications in FIG. 11 are examples; other components may be used.

The portal common unit 1202, the application common unit 1203, and the common client unit 1204 in FIG. 11 function as a framework and a platform of the portal. For example, the portal common unit 1202, the application common unit 1203, and the common client unit 1204 collectively provide general-purpose functions to the portal application unit 1201.

The portal common unit 1202 has a configuration including a pre/post processing unit 1231 and a base unit 1232. Furthermore, the pre/post processing unit 1231 has a configuration including a user information acquiring unit 1241 and a request recording unit 1242.

The portal common unit 1202 uses the application common unit 1203 and the common client unit 1204 and provides functions to the portal application unit 1201. Note that details of processes performed by the portal common unit 1202 are described below.

The application common unit 1203 has a configuration including a thread information unit 1251 and a log recording unit 1252. The application common unit 1203 is used by the portal common unit 1202 and the common client unit 1204. Note that details of processes performed by the application common unit 1203 are described below.

The common client unit 1204 has a configuration including a service management client 1261, a user management client 1262, a DB client 1263, a mail transmission client 1264, an asynchronous job client 1265, and a communication client 1266. The common client unit 1204 uses the application common unit 1203. Furthermore, the common client unit 1204 is used by the portal common unit 1202.

The common client unit 1204 includes a base service 1205 described below, and client functions for other applications 1101. Note that details of processes performed by the common client unit 1204 are described below.

The base service 1205 of FIG. 11 expresses the integrated base in the service providing system 1100 illustrated in FIG. 4, etc., as another format. The base service 1205 corresponds to the common services 1102, the database 1103, and the platform API 1104 in the service providing system 1100 illustrated in FIG. 4, etc.

The base service 1205 of FIG. 11 has a configuration including an authentication/user management unit 1271, a service/license management unit 1272, a database 1273, a storage 1274, and an asynchronous job execution unit 1275.

### Details of Process

Log-in

For example, a web browser 1280 installed in the client terminal 1011 of FIG. 1 receives a log-in screen from, for example, the portal service application 1111, when the user inputs the URL of a log-in screen as the access destination or as the user selects the log-in screen from a bookmark, for example.

The web browser 1280 displays the log-in screen. The user inputs, in the displayed log-in screen, an organization ID, a user ID, and a password, and presses a log-in button. When the log-in button is pressed, the web browser 1280 requests the portal service application 1111 to log in. Note that the request to log in includes the organization ID, the user ID, and the password.

The portal service application 1111 requests the authentication/authorization unit 1121 to log in by the organization ID, the user ID, and the password included in the request to log in from the web browser 1280. The authentication/authorization unit 1121 confirms whether the combination of the organization ID, the user ID, and the password included in the request to log in from portal service application 1111 is stored in the user information storage unit 1143 as user information as illustrated in FIG. 6.

When the combination of the organization ID, the user ID, and the password included in the request to log in is stored in the user information storage unit 1143, the authentication/authorization unit 1121 returns log-in information such as an authentication ticket to the web browser 1280. The log-in information is received with the use of a cookie, etc. After acquiring the log-in information, the web browser 1280 can specify log-in information and request the portal service application 1111 to display the user management screen and the application launcher screen as described below.

### Display of User Management Screen

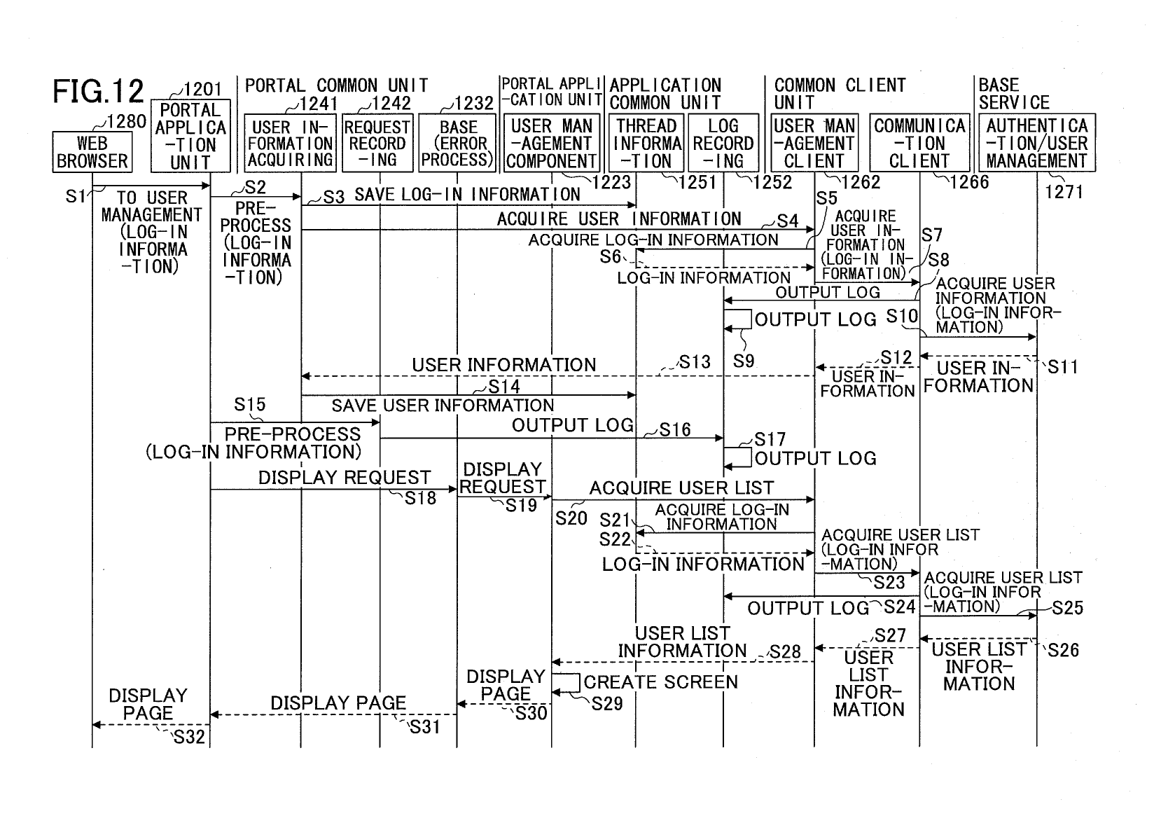

FIG. 12 is a sequence diagram expressing an example of processing procedures for displaying a user management screen. When the user requests the display of the user management screen, in step S1, the web browser 1280 specifies log-in information and requests the portal application unit 1201 to display a user management screen.

In step S2, the portal application unit 1201 specifies log-in information and requests the user information acquiring unit 1241 of the portal common unit 1202 to perform a pre-process. In step S3, the user information acquiring unit 1241 saves the log-in information in the thread information unit 1251 of the application common unit 1203. In step S4, the user information acquiring unit 1241 requests the user management client 1262 of the common client unit 1204 to acquire user information.

In step S5, the user management client 1262 requests the thread information unit 1251 to acquire log-in information. In step S6, the user management client 1262 acquires log-in information from the thread information unit 1251.

In step S7, the user management client 1262 specifies log-in information and requests the communication client 1266 to acquire user information. In step S8, the communication client 1266 requests the log recording unit 1252 of the application common unit 1203 to output a log. In step S9, the log recording unit 1252 outputs a log. Furthermore, in step S10, the communication client 1266 specifies log-in information and requests the authentication/user management unit 1271 of the base service 1205 to acquire user information.

The authentication/user management unit 1271 acquires user information associated with log-in information from, for example, the DB 1273. In step S11, the authentication/user management unit 1271 provides the acquired user information to the communication client 1266. Note that the user information mentioned here is information such as the organization, the name, and the role of the user.

In step S12, the communication client 1266 provides the user information received from the authentication/user management unit 1271 to the user management client 1262. In step S13, the user management client 1262 provides the received user information to the user information acquiring unit 1241. In step S14, the user information acquiring unit 1241 saves the user information in the thread information unit 1251 of the application common unit 1203. Note that the user information saved in the thread information unit 1251 may include a language setting received by a HTTP header from the web browser 1280.

In step S15, the portal application unit 1201 specifies log-in information and requests the request recording unit 1242 of the portal common unit 1202 to perform a pre-process. In step S16, the request recording unit 1242 requests the log recording unit 1252 of the application common unit 1203 to output a log. In step S17, the log recording unit 1252 outputs a log.

In step S18, the portal application unit 1201 makes a display request to the base unit 1232 of the portal common unit 1202. In step S19, the base unit 1232 makes a display request to the user management component 1223 of the portal application unit 1201. When the user management component 1223 receives a display request, the user management component 1223 starts a process of displaying the user management screen of the organization of the user identified by the log-in information.

In step S20, the user management component 1223 requests the user management client 1262 of the common client unit 1204 to acquire a user list. In step S21, the user management client 1262 requests the thread information unit 1251 to acquire log-in information. In step S22, the user management client 1262 acquires log-in information.

In step S23, the user management client 1262 specifies log-in information and requests the communication client 1266 to acquire the user list. In step S24, the communication client 1266 requests the log recording unit 1252 of the application common unit 1203 to output a log. The log recording unit 1252 outputs the log. Furthermore, in step S25, the user support component 1226 specifies log-in information and requests the authentication/user management unit 1271 of the base service 1205 to acquire the user list.

The authentication/user management unit 1271 acquires the user list information associated with the log-in information from, for example, the DB 1273. Note that the user list information associated with the log-in information is a list of users belonging to the organization, if the log-in user is, for example, an administrator. Furthermore, the user list information associated with the log-in information may not be a list of users, but may be information of the log-in user, if the log-in user is, for example, a general user.

In step S26, the authentication/user management unit 1271 provides the acquired user list information to the communication client 1266. In step S27, the communication client 1266 provides the user list information received from the authentication/user management unit 1271, to the user management client 1262.

In step S28, the user management client 1262 provides the received user list information to the user management component 1223. In step S29, the user management component 1223 creates a user list of the user management screen based on the user list information. Note that the user management component 1223 may create information of the log-in user instead of the user list, when the log-in user is a general user.

In step S30, the user management component 1223 requests the base unit 1232 to display the user management screen. The process proceeds to step S31, and the base unit 1232 requests the portal application unit 1201 to display the user management screen. In step S32, the portal application unit 1201 causes the web browser 1280 to display the user management screen.

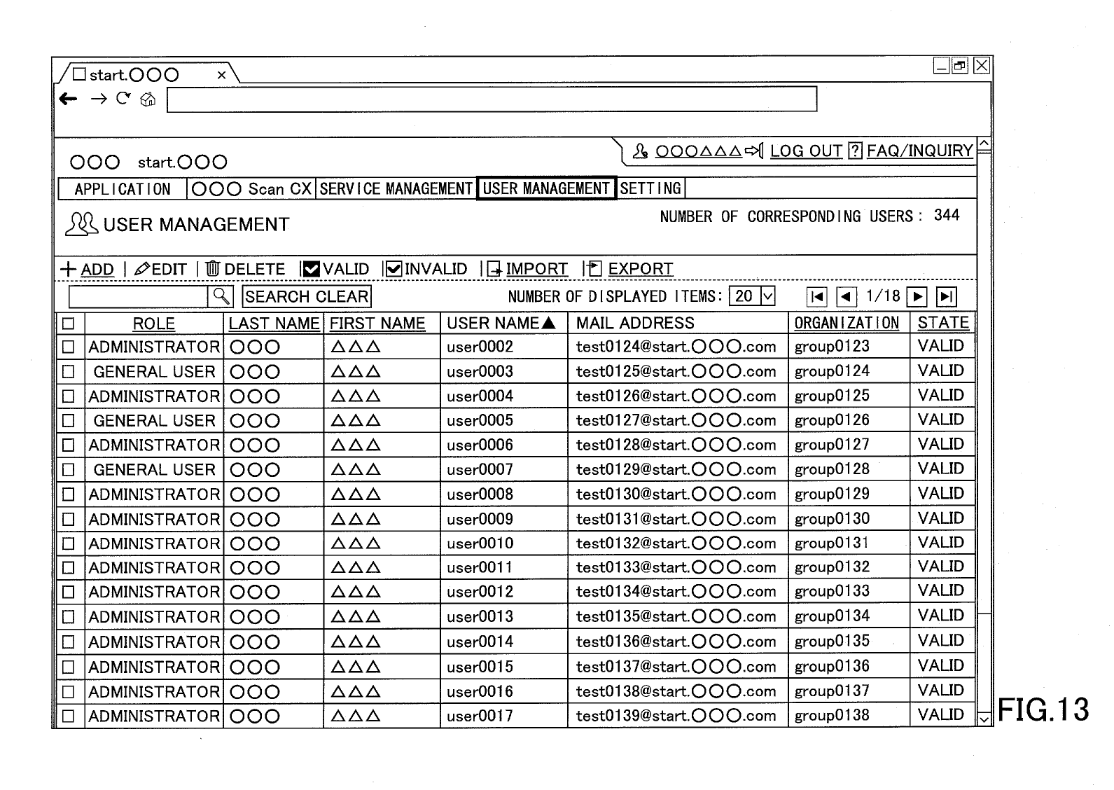

FIG. 13 is an image diagram of an example of a user management screen. The user management screen of FIG. 13 is an example where the log-in user is an administrator. Because the log-in user is an administrator, a user list is displayed in the user management screen of FIG. 13.

As indicated in the sequence diagram of FIG. 12, in the portal service application 1111, by saving the log-in information of the log-in user in the thread information unit 1251 of the application common unit 1203, the log-in information can be shared in the common client unit 1204. Furthermore, as the log recording unit 1252 is provided in the application common unit 1203, the function of outputting a log can be shared in the portal common unit 1202 and the common client unit 1204.

Note that with the sequence diagram of FIG. 12, a description is given of an example of requesting the display of the user management screen; however, the same applies to a case of requesting the display of a service management screen. For example, when the display of a service management screen is requested, the portal application unit 1201 makes a display request to the base unit 1232 of the portal common unit 1202.

The base unit 1232 makes a display request to the service management component 1224 of the portal application unit 1201. When the service management component 1224 receives a display request, the service management component 1224 starts a process for displaying a service management screen of the organization of a user identified by log-in information.

The service management component 1224 requests the service management client 1261 of the common client unit 1204 to acquire a service list. The service management client 1261 requests the thread information unit 1251 to acquire log-in information. The service management client 1261 acquires log-in information. The service management client 1261 specifies log-in information and requests the communication client 1266 to acquire a service list.

The communication client 1266 requests the log recording unit 1252 of the application common unit 1203 to output a log. The log recording unit 1252 outputs a log. The communication client 1266 specifies log-in information and requests the service/license management unit 1272 of the base service 1205 to acquire a service list.

The service/license management unit 1272 acquires service list information associated with the log-in information from, for example, the DB 1273. The service/license management unit 1272 provides the service list information to the communication client 1266. The communication client 1266 provides the service list information received from the service/license management unit 1272, to the service management client 1261.

The service management client 1261 provides the service list information to the service management component 1224. Then, the service management component 1224 creates a service list of the service management screen, based on the service list information.

The service management component 1224 requests the base unit 1232 to display the service management screen. The base unit 1232 requests the portal application unit 1201 to display the service management screen. The portal application unit 1201 causes the web browser 1280 to display the service management screen.

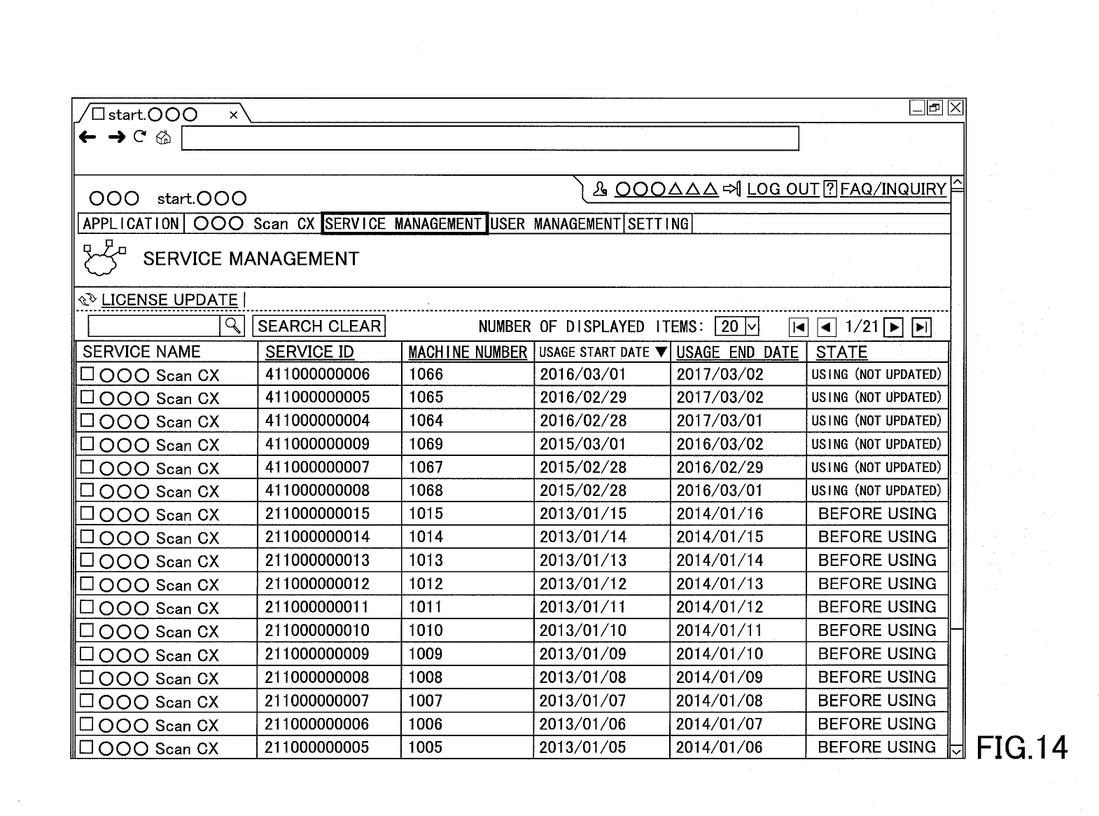

FIG. 14 is an image diagram of an example of a service management screen. The service management screen of FIG. 14 expresses an example where a list of licenses of valid services belonging to the organization of a log-in user is displayed.

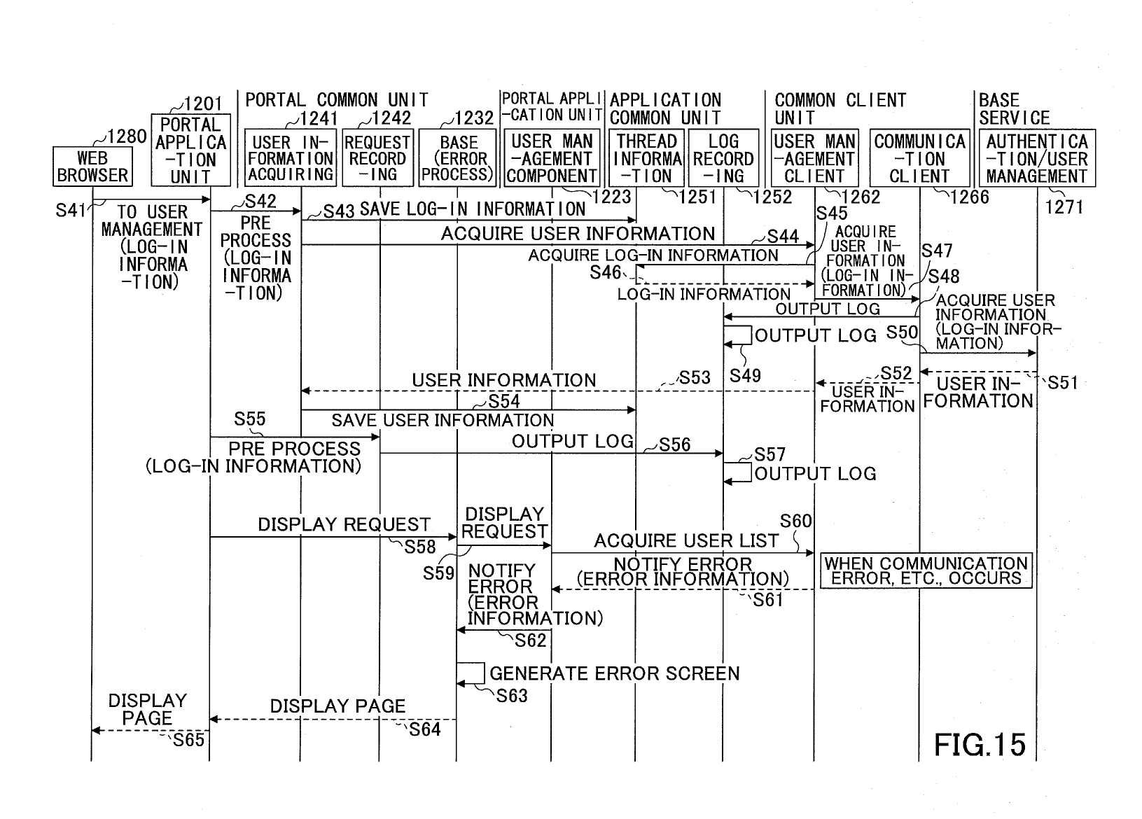

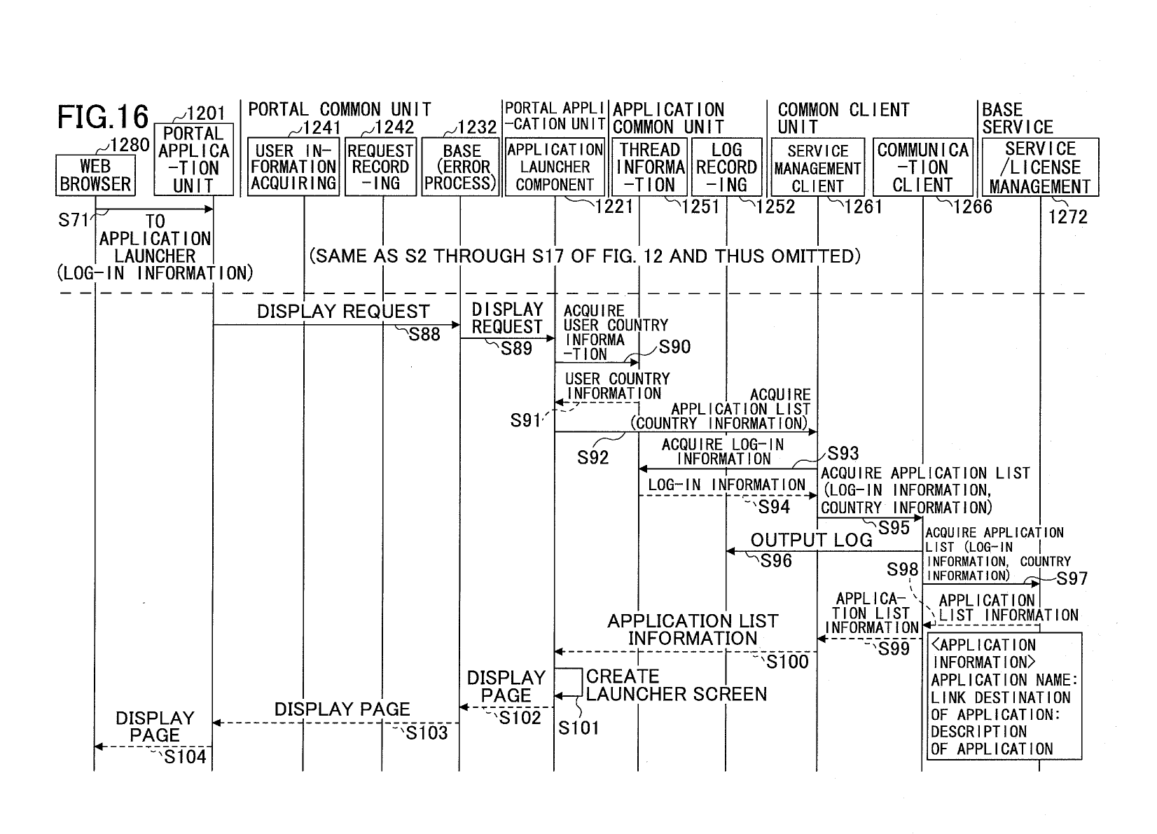

When an error such as a communication error occurs, the process of the sequence diagram illustrated in FIG. 12 becomes the sequence diagram illustrated in FIG. 15. FIG. 15 is a sequence diagram expressing an example of processing procedures for displaying a user management screen when an error occurs. Note that the processes of steps S41 through S57 are the same as the processes of steps S1 through S17 of FIG. 12, and therefore descriptions thereof are omitted.

In step S58, the portal application unit 1201 makes a display request to the base unit 1232 of the portal common unit 1202. In step S59, the base unit 1232 makes a display request to the user management component 1223 of the portal application unit 1201. When the display request is received, the user management component 1223 starts a process for displaying a user management screen of the user identified by the log-in information.

In step S60, the user management component 1223 requests the user management client 1262 of the common client unit 1204 to acquire the user list. Note that the sequence diagram of FIG. 15 indicates a case where an error such as a communication error occurs after step S60.

In step S61, the user management client 1262 specifies error information relevant to the error that has occurred, and issues an error notification to the user management component 1223. The user management component 1223 receives the error notification in which error information is specified. The user management component 1223 determines whether error handling is to be performed on the error, based on error information. When error handling is to be performed on the error, in step S62, the user management component 1223 specifies error information and issues an error notification to the base unit 1232 of the portal common unit 1202. Note that when error handling is not to be performed on the error, the user management component 1223 does not do anything.

When an error notification in which error information is specified is received, in step S63, the base unit 1232 generates an error screen based on the error information. The process proceeds to step S64, and the base unit 1232 requests the portal application unit 1201 to display an error screen. In step S65, the portal application unit 1201 causes the web browser 1280 to display an error screen.

As illustrated in the sequence diagram of FIG. 15, in the portal service application 1111, the base unit 1232 of the portal common unit 1202 is the base class, and the user management component 1223 of the portal application unit 1201 becomes the sub class. The display request flows from the base unit 1232 that is the base class to the user management component 1223 that is the sub class.

Unless an error occurs, the user management component 1223 that is the sub class generates a screen. On the other hand, when an error occurs, the user management component 1223 that is the sub class returns the error to the base unit 1232 that is the base class. The base unit 1232 that has received the returned error generates a screen. As described above, in the portal service application 1111, the portal common unit 1202 includes an error process.

Therefore, in the portal service application 1111, an error process, which is performed in a case where an error occurs for which error handling is to be uniquely performed, can be shared in the portal application unit 1201.

### Display of Application Launcher

FIG. 16 is a sequence diagram expressing an example of processing procedures for displaying an application launcher screen. The sequence diagram of FIG. 16 includes the same processes as those in the sequence diagram of FIG. 12. Thus, descriptions are appropriately omitted for the same processes as those in the sequence diagram of FIG. 12.

When the user requests the display of an application launcher screen, in step S71, the web browser 1280 specifies log-in information and requests the portal application unit 1201 to display an application launcher screen. After the process of step S71, the processes up to step S88 are the same as steps S2 through S17 of FIG. 12, and therefore descriptions thereof are omitted.

In step S88, the portal application unit 1201 makes a display request to the base unit 1232 of the portal common unit 1202. In step S89, the base unit 1232 makes a display request to the application launcher component 1221 of the portal application unit 1201.

When the application launcher component 1221 receives the display request, the application launcher component 1221 starts the process for displaying an application launcher screen. For example, the application launcher screen is for displaying a list of applications that can be used in the country to which the organization of the log-in user belongs.

In step S90, the application launcher component 1221 requests for country information of the log-in user to the thread information unit 1251 of the application common unit 1203. In step S91, the application launcher component 1221 acquires the country information of the log-in user (user country information) from the thread information unit 1251. Note that if applications that can be used are not different among countries, the processes of steps S90 and S91 are unnecessary.

In step S92, the application launcher component 1221 specifies country information and requests the service management client 1261 of the common client unit 1204 to acquire an application list. In step S93, the service management client 1261 requests the thread information unit 1251 to acquire log-in information. In step S94, the service management client 1261 acquires log-in information.

In step S95, the service management client 1261 specifies log-in information and country information and requests the communication client 1266 to acquire an application list. In step S96, the communication client 1266 requests the log recording unit 1252 of the application common unit 1203 to output a log. The log recording unit 1252 outputs a log. Furthermore, in step S97, the communication client 1266 specifies the log-in information and the country information and requests the service/license management unit 1272 of the base service 1205 to acquire an application list.

The service/license management unit 1272 acquires application list information associated with the log-in information and country information from, for example, the DB 1273. The application list information has a configuration including one or more application information items. The application information includes information such as an application name, a link destination of the application, and a description of the application.

In step S98, the service/license management unit 1272 provides the acquired application list information to the communication client 1266. In step S99, the communication client 1266 provides the application list information received from the service/license management unit 1272, to the service management client 1261.

In step S100, the service management client 1261 provides the received application list information to the application launcher component 1221. In step S101, the application launcher component 1221 creates an application launcher screen based on the application list information. Note that the application launcher component 1221 may create different application launcher screens, based on whether the log-in user is an administrator or a general user.

In step S102, the application launcher component 1221 requests the base unit 1232 to display an application launcher screen. The process proceeds to step S103, and the base unit 1232 requests the portal application unit 1201 to display the application launcher screen. In step S104, the portal application unit 1201 causes the web browser 1280 to display the application launcher screen.

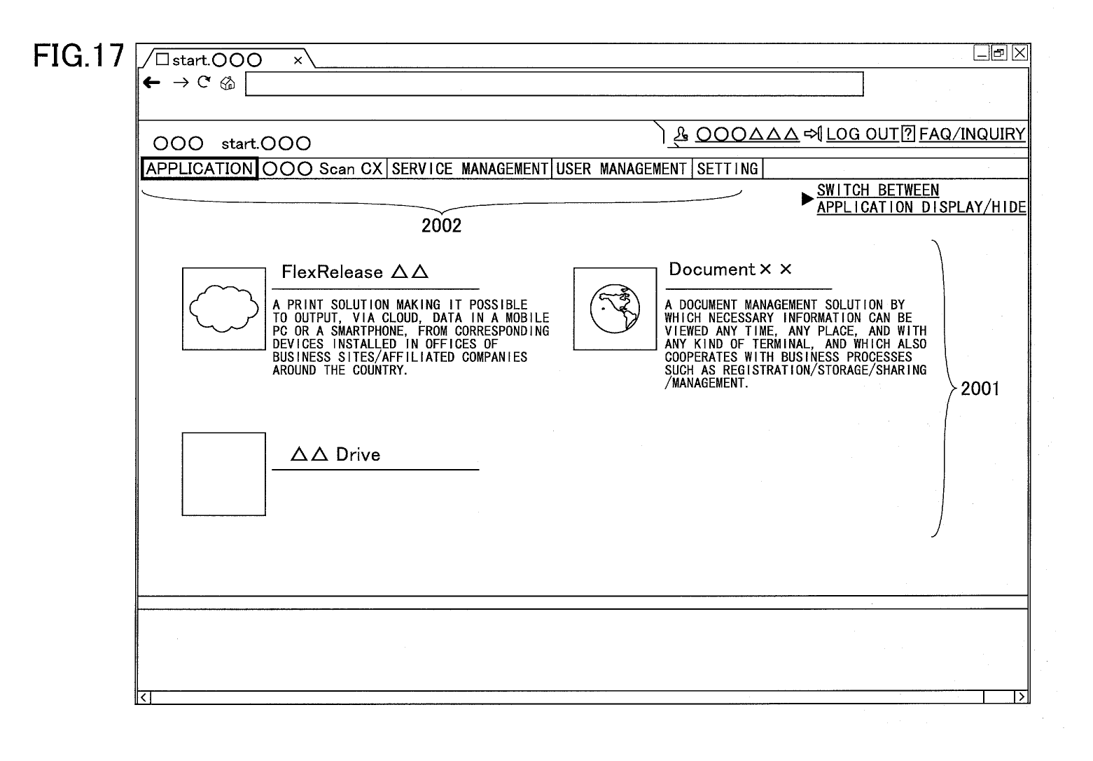

FIG. 17 is an image diagram of an example of an application launcher screen. The application launcher screen in FIG. 17 indicates an example where the log-in user is an administrator. As the log-in user is an administrator, the application launcher screen in FIG. 17 includes icons 2001 of applications (services) that can be used, and tabs 2002 of a plurality of applications (services) that can be used.

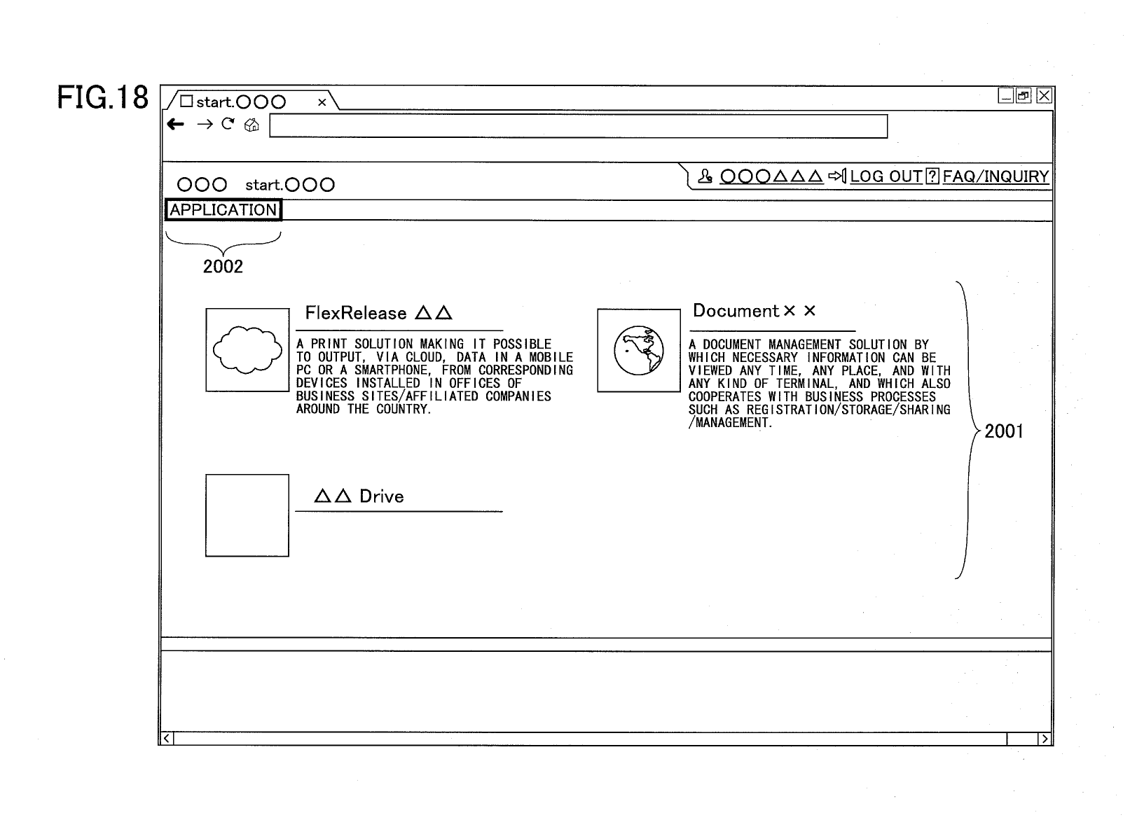

FIG. 18 is an image diagram of another example of an application launcher screen. The application launcher screen in FIG. 18 indicates an example where the log-in user is a general user. The application launcher screen in FIG. 18 also includes icons 2001 of applications (services) that can be used, and tabs 2002 of a plurality of applications (services) that can be used; however, a smaller number of tabs are included compared to the application launcher screen in FIG. 17.

Note that in step S98 of FIG. 16, the service/license management unit 1272 may refer to the DB 1273, and may provide list information of applications (services) that the user can use, to the communication client 1266. In this case, in step S101, the application launcher component 1221 may control the displaying/hiding of the icons 2001 and tabs 2002 in the application launcher screen, based on the list information of applications (services) that the log-in user can use.

As indicated in the sequence diagram of FIG. 16, in the portal service application 1111, different application launcher screens may be created based on the applications (services) that the user can use. Furthermore, in the portal service application 1111, different application launcher screens may be created based on whether the log-in user is an administrator or a general user.

### Application Cooperation

The portal service application 1111 illustrated in FIG. 11 cooperates with, for example, the scan service application 1112 and the print service application 1113 in FIG. 4, as follows.

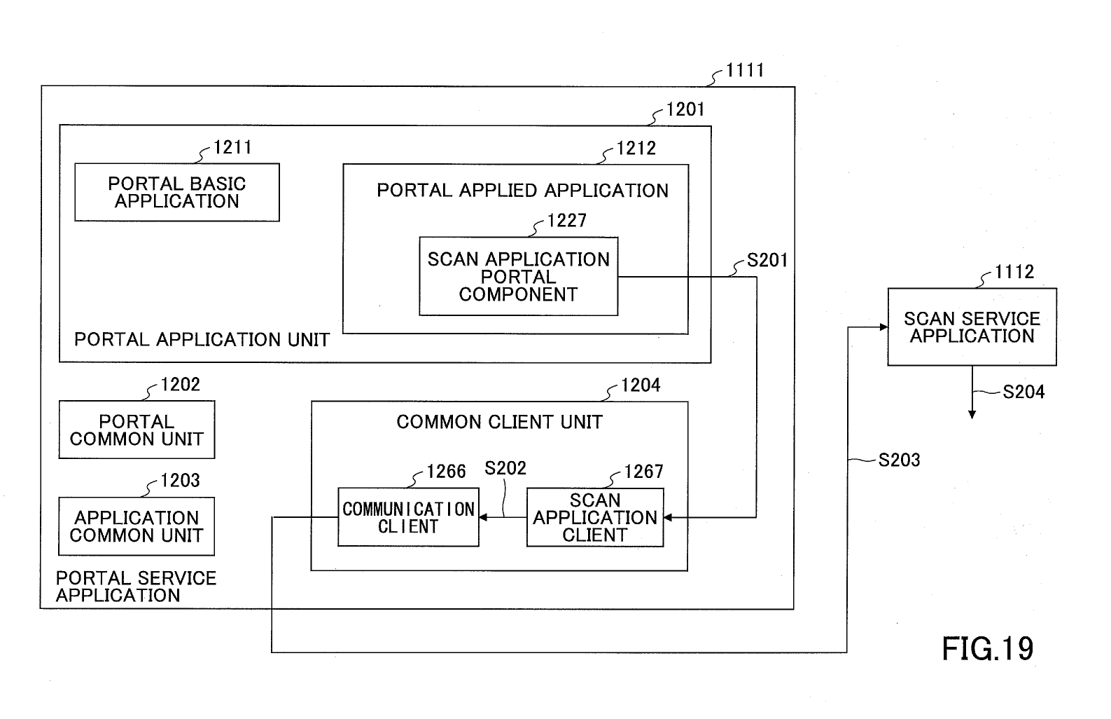

FIG. 19 is an explanatory diagram expressing the processing procedures performed by the scan service application for acquiring setting information from the base service. When acquiring setting information from the base service 1205, the scan application portal component 1227, which is included as an example of the component 1212 of a portal applied application in the portal service application 1111, performs the process of step S201.

In step S201, the scan application portal component 1227 requests a scan application client 1267 of the common client unit 1204 to acquire setting information.

In step S202, the scan application client 1267 requests the communication client 1266 to acquire setting information. In step S203, the communication client 1266 requests the scan service application 1112 to acquire setting information. In step S204, the scan service application 1112 can read the setting information from the base service 1205.

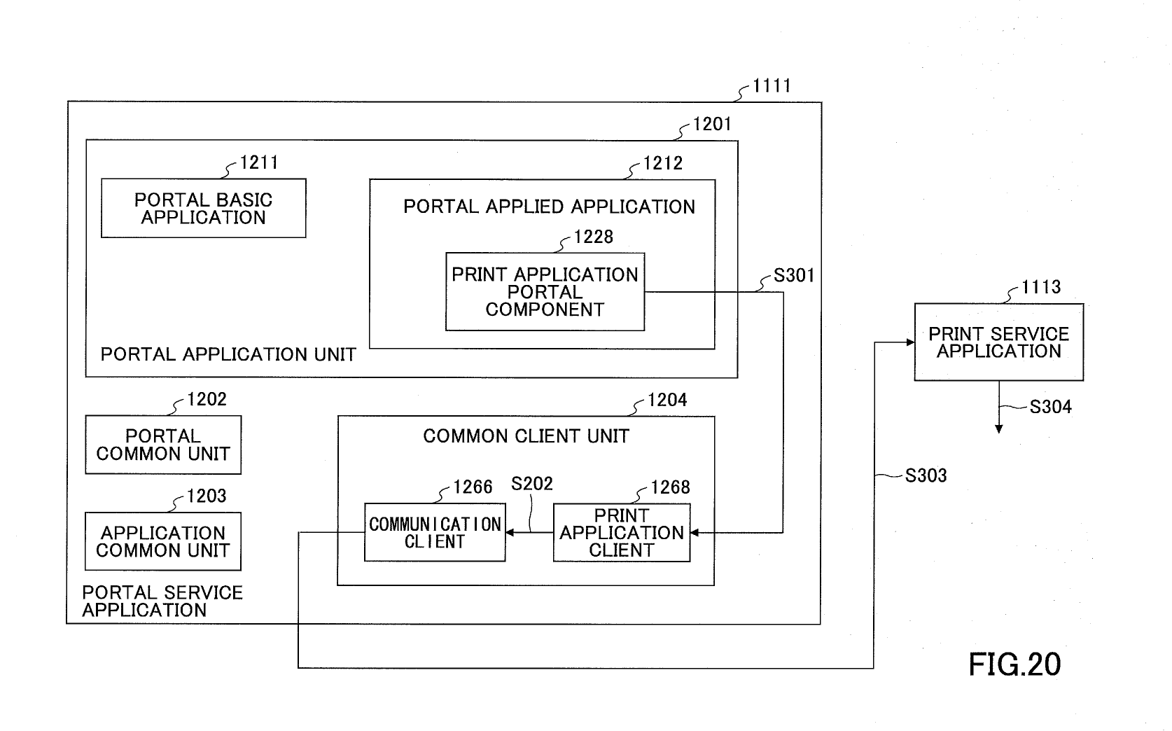

FIG. 20 is an explanatory diagram expressing the processing procedures performed by the print service application for registering jobs in the base service. When registering jobs in the base service 1205, the print application portal component 1228, which is included as an example of the component 1212 of a portal applied application in the portal service application 1111, performs the process of step S301.

In step S301, the print application portal component 1228 requests a print application client 1268 of the common client unit 1204 to register a job.

In step S302, the print application client 1268 requests the communication client 1266 to register a job. In step S303, the communication client 1266 requests the print service application 1113 to register a job. In step S304, the print service application 1113 can register a job in the base service 1205.

As described above, the portal service application 1111 of FIG. 11 can perform a process in cooperation with the scan service application 1112 and the print service application 1113, etc. For example, when performing a process in cooperation with the scan service application 1112, the scan application portal component 1227 and the scan application client 1267 are to be added to the portal service application 1111.

Note that the scan service application 1112 and the print service application 1113 may be provided as, for example, a function provided by the portal common unit 1202, the application common unit 1203, or the common client unit 1204.

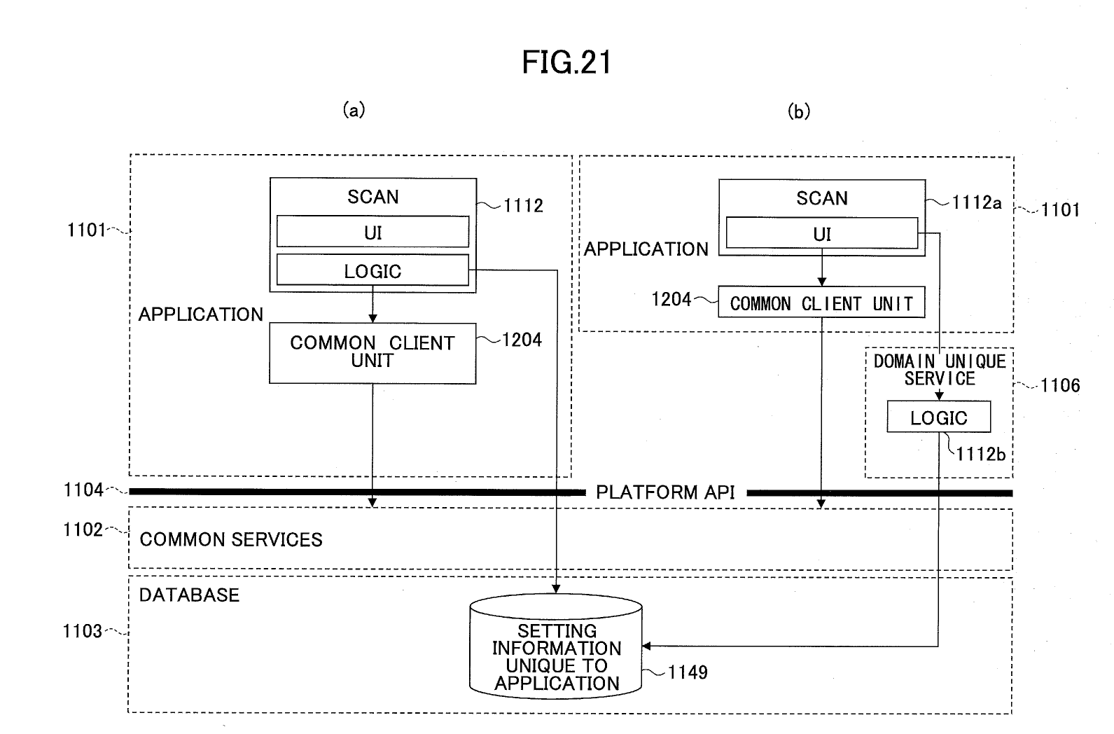

The scan service application 1112 and the print service application 1113, etc., illustrated in FIG. 4 or FIG. 10 may be created by, for example, a configuration as illustrated in FIG. 21, using the common client unit 1204 illustrated in FIG. 21.

FIG. 21 is a configuration diagram of an example of an application using the common client unit. FIG. 21(a) corresponds to the configuration of the service providing system 1100 illustrated in FIG. 4. FIG. 21(b) corresponds to the configuration of the service providing system 1100 illustrated in FIG. 10.

FIG. 21(a) is a configuration in which the scan service application 1112 includes a UI unit and a logic unit. The UI unit of the scan service application 1112 requests the logic unit to perform a process for using the common services 1102 and the database 1103. The logic unit of the scan service application 1112 can use the common services 1102 and the database 1103 by using the common client unit 1204 or the platform API 1104 of the portal service application 1111.

FIG. 21(b) is configuration in which a UI unit 1112a of the scan service application and a logic unit 1112b of the scan service application are separated. The UI unit 1112a of the scan service application requests the common client unit 1204 to perform a process for using the common services 1102 and the database 1103, and can use the common services 1102 and the database 1103. Furthermore, the UI unit 1112a of the scan service application requests the logic unit 1112b of the scan service application to perform a process for using the common services 1102 and the database 1103, and can use the common services 1102 and the database 1103.

### Overview

In the service providing system 1100 according to the first embodiment, the functions that are commonly by the portal service application 1111 constitute a platform as common functions, such as the portal common unit 1202, the application common unit 1203, and the common client unit 1204.

The portal service application 1111 includes the components 1211 of portal basic applications using common functions of the portal service application 1111. Furthermore, the portal service application 1111 can create the components 1212 of portal applied applications by using common functions of the portal service application 1111.

Therefore, in the service providing system 1100 according to the first embodiment, the functions commonly used by the portal service application 1111 constitute a platform as common functions, and therefore development of the portal service application 1111 is facilitated.

The information processing system, the information processing device, and the method are not limited to the specific embodiments described herein, and variations and modifications may be made without departing from the spirit and scope of the present invention. For example, in the present embodiment, cooperation by the scan service application 1112 and the print service application 1113 is described as one example; however, the present invention is also applicable to applications 1101 other than the scan service application 1112 and the print service application 1113.

The portal application unit 1201 corresponds to a display control unit. The portal common unit 1202, the application common unit 1203, and the common client unit 1204 correspond to a common function providing unit. The base service 1205 corresponds to a base function providing unit. Process performed by the components 1211 of portal basic applications correspond to one or more basic processes.

Furthermore, the common client unit 1204 corresponds to a common client unit. The portal common unit 1202 corresponds to a first common unit. The application common unit 1203 corresponds to a second common unit. The thread information unit 1251 corresponds to a thread information providing unit. The log recording unit 1252 corresponds to a log recording unit.

According to one embodiment of the present invention, an information processing system, an information processing device, and a method are provided, which are capable of facilitating the development of portal service.

The present application is based on and claims the benefit of priority of Japanese Priority Patent Application No. 2013-021268, filed on Feb. 6, 2013 and Japanese Priority Patent Application No. 2014-007160, filed on Jan. 17, 2014, the entire contents of which are hereby incorporated herein by reference.

What is claimed is:

1. An information processing system including one or more information processing devices, the information processing system comprising:
a display control unit configured to provide, to an external device, a screen of one or more basic processes relevant to a portal service;
a common function providing unit configured to provide, to the display control unit, one or more common functions used by the one or more basic processes; and
a base function providing unit configured to provide a base function to the common function providing unit.

2. The information processing system according to claim 1, wherein
the common function providing unit includes
a common client unit configured to provide a client function to the base function providing unit,
a first common unit configured to use the client function provided by the common client unit, and provide a function to the display control unit, and
a second common unit configured to provide a function that is commonly used by the common client unit and the first common unit.

3. The information processing system according to claim 2, wherein
the second common unit includes
a thread information providing unit configured to save log-in information received from the first common unit, and provide the log-in information based on an acquisition request from the common client unit.

4. The information processing system according to claim 3, wherein
the second common unit further includes
a log recording unit configured to record a log, based on an output request from the common client unit and the first common unit.

5. The information processing system according to claim 2, wherein
the first common unit performs an error process on the external device when an error occurs in the client function provided by the common client unit.

6. The information processing system according to claim 2, wherein
the display control unit further provides, to the external device, one or more screens relevant to an applied service.

7. The information processing system according to claim 6, wherein
when the display control unit receives, from the external device, a request to execute a process relevant to the applied service, the display control unit requests, via the common client unit, an applied service providing unit providing the applied service to execute the process relevant to the applied service.

8. The information processing system according to claim 1, wherein
the screen of the one or more basic processes includes at least one of a user management screen, a service management screen, and a service list screen.

9. An information processing device comprising:
a display control unit configured to provide, to an external device, a screen of one or more basic processes relevant to a portal service;
a common function providing unit configured to provide, to the display control unit, one or more common functions used by the one or more basic processes; and
a base function providing unit configured to provide a base function to the common function providing unit.

10. A method performed by an information processing system including one or more information processing devices, the method comprising:
providing, by a display control unit, to an external device, a screen of one or more basic processes relevant to a portal service;
providing, by a common function providing unit, to the display control unit, one or more common functions used by the one or more basic processes; and
providing, by a base function providing unit, a base function to the common function providing unit.
